(19) United States
(12) Patent Application Publication
(10) Pub. No.: US 2006/0261522 A1
(43) Pub. Date: Nov. 23, 2006

(54) System and method for vaporizing a solid material

(76) Inventors: Tihiro Ohkawa, La Jolla, CA (US); Karl R. Umstadter, San Diego, CA (US)

Correspondence Address: NEIL K. NYDEGGER;NYDEGGER & ASSOCIATES, 348 Olive Street, San Diego, CA, 92103, US

(21) Appl. No.: 11/131,961

(22) Filed: May 18, 2005

(51) Int. Cl. B23K 26/38

(52) U.S. Cl. 264/400; 219/121.69; 219/121.68

(57) ABSTRACT

A laser device and method, for vaporizing a solid material, requires mixing silica with a metal oxide to prepare a mixture. The mixture is then sintered to create a ceramic brick having a thermal expansion coefficient below 5×10⁻⁶/° K. In operation, the device generates a laser beam, with a predetermined power density at a point on the laser beam. This point on the laser beam is then moved along a path on the brick to create a melt zone for the material at the point. This is done with a movement of the melt zone, at a speed within a range of predetermined operational parameters, to transition the material from a solid to a vapor.

### FIELD OF THE INVENTION

The present invention pertains generally to systems and methods for using a laser to vaporize materials. More particularly, the present invention pertains to systems and methods for using lasers to vaporize ceramics and mixtures of non-metallic compounds. The present invention is particularly, but not exclusively, useful for creating a vapor with a vapor jet production process so that the vapor can be injected into a plasma.

### BACKGROUND OF THE INVENTION

Vapors from a variety of materials can be useful for many different industrial purposes, such as in vapor deposition procedures or material purification processes. Regardless of the particular purpose, however, whenever a vapor is being generated, it is desirable that the vapor has certain determinable characteristics or attributes. In particular, it is desirable that as much of the target material as possible be actually vaporized.

An important consideration for the creation of a vapor involves the selection of a system that will be effective for the particular purpose. For some applications, the use of an oven may be appropriate. Ovens, however, can be cumbersome and allow for uneven vapor jet production of the target material. This is particularly so if the target material is mixed or heterogeneous. For this reason, among others, various irradiation systems have been suggested as an alternative to ovens.

Commercially available microwave radiation is known to be capable of generating the heat loads that are required to vaporize many materials. The electric field that is associated with microwave radiation, however, can induce an ionization that in some applications may cause a reflection of the microwave radiation before it reaches the target. This, of course, will reduce the efficiency of the system. It happens, however, that laser radiation is also known to be effective for the purpose of vaporizing materials. Importantly, a laser source can be controlled to minimize ionization of the resultant vapor.

With specific regard to the use of ceramic materials as the target in a vaporization process, when a laser is to be used to vaporize such materials, thermal shock is a major concern. Specifically, the concern here arises because ceramics are not particularly ductile and, therefore, they do not tolerate excessive strain. Instead, when subjected to high strains they simply crack, or break. In the particular case where a laser beam is focused onto a ceramic material (e.g. for vaporization of the material), the focal spot of the laser can easily have temperatures in excess of several thousand degrees Centigrade. Because ceramics typically have low thermal conductivity, a high thermal gradient will result. Specifically, while material at the laser focal spot is very hot, material that is quite near the focal spot may remain relatively cold. Further, because ceramics typically have a high coefficient of thermal expansion, the temperature differential due to the increased heat load at the laser focal spot will create strains in the ceramic material. When these strains exceed the critical strain of the ceramic material, the result is thermal shock.

With the above in mind, ceramic materials with improved properties for resisting thermal shock have been developed for use in various industrial applications. Heretofore, however, the intended end use for such materials has been as a solid. For example, Ceramit is a commercial grade product of the mineral pyrophylite that is in a solid form and is machinable for use in the manufacture of prototypes and other such productions (see http://www.azom.com). In these applications there is no suggestion of using the ceramic as a target for a vaporization process. Nevertheless, there are potentially other applications, such a waste remediation, wherein the vaporization of a ceramic may be desirable. In particular, this may be so for the disposal of metallic oxide waste products. One benefit here is that, as a ceramic, the metal oxide waste products can be more easily handled prior to vaporization and their eventual disposal.

As a heat source for a vaporization process, it is known that laser light can be used as an effective heat source for such a purpose. Further, depending on the particular material that is to be vaporized, it can be shown that in the transition from solid, to liquid, to gas (vapor), a laser heat source can be controlled to make the presence of the liquid phase apparently insignificant. Consequently, as long as thermal fracture can be avoided, the main concern for vaporizing the solid material involves controlling the interaction of the laser beam with the target material. This is done, of course, with a view toward maximizing the efficiency of the process. To this end, however, certain operational boundaries must be observed.

During the evaporation of a ceramic material (i.e. boiling), under substantially ambient conditions, it can be shown that the particle flux density of the material, Γ, becomes:
Γ=5.8×10²⁹[AT_{b}]^{-1/2} [Eqn. 1]
where “A” is the molecular weight of the material and T_{b} is the normal boiling point. The erosion velocity “u” of the material can then be expressed as:
u=Γ/nₛ [Eqn. 2]
where “nₛ” is the solid number density of the target material. When a laser beam is to be used as the heat source for the vaporization of the solid target material, it will be appreciated that the vaporization process occurs in a melt zone, where the laser beam is focused onto the target material. The area of this melt zone, on which the laser beam is incident, is taken to be “S”. Further, it can be shown mathematically that the depth “δ” of the melt zone (i.e. where there is a presence of the target material's liquid phase) can be estimated by the expression:
δ=[κ/C]/u [Eqn. 3]
where “κ” is the thermal conductivity of the target material, and “C” is the heat capacity of the material.

As indicated above, when the presence of a liquid phase in a solid vaporization process can be considered insignificant (i.e. when “δ” is small in comparison with “S”), movement of the melt zone on the target material becomes of paramount importance. With this in mind, consider the fact that when a laser beam is scanned over a surface of target material to move a melt zone at a speed “w”, a trench will result. Specifically, the resultant trench will have a width that is approximated by √S, and it will have a depth “h”. In this case, the depth “h” can be expressed as:
h=√Su/w [Eqn. 4]

It can then be mathematically shown that optimal operating conditions for the vaporization of a solid target material are achieved when the scanning speed “w” of a laser beam heat source is maintained in a range where:
u<<w<<[√S/δ]u [Eqn. 5]

In light of the above, it is an object of the present invention to provide a system and method for effectively vaporizing a ceramic material with a laser beam. Another object of the present invention is to provide a system and method for vaporizing a material with a laser beam that is functional within predetermined operational parameters. Yet another object of the present invention is to provide a system and method for vaporizing a solid material with a laser beam that avoids ionization of the resultant vapor. Still another object of the present invention is to provide a system and method for vaporizing a solid material that is simple to use, is relatively easy to manufacture, and is comparatively cost effective.

### SUMMARY OF THE INVENTION

In accordance with the present invention, the vaporization of certain solid materials (e.g. metallic oxides) is facilitated by first preparing them as a ceramic. In accordance with the present invention, the metal oxide that is to be vaporized is mixed with silica (SiO₂). This mixture is then sintered to create the ceramic. In this process the ratio of metallic oxide waste to silica is specifically selected to establish a desired coefficient of thermal expansion in the ceramic. More specifically, the ratio is selected to maintain the solid material (i.e. ceramic) below its critical strain, when the ceramic (solid material) is heated to a temperature above approximately two thousand degrees Centigrade. A consequence of this is that the solid material (ceramic) that is manufactured for use with the present invention will effectively resist thermal shock as it is being vaporized by a laser beam. As a practical matter, this means the ceramic will have a thermal expansion coefficient that is generally below 5×10⁻⁶/° K. To accomplish this, in the manufacture of the ceramic, the ratio of metallic oxide waste to silica will preferably be around 1:1.

When used for the present invention, the ceramic solid material that is prepared can be formed as desired. Preferably, however, it will be formed as a brick or block that has a substantially flat surface. As envisioned for the present invention, the flat surface of the ceramic solid material will be a target surface onto which a laser beam can be focused for vaporization of the brick (block).

In accordance with the present invention, a device for vaporizing a solid target material also includes a source for generating a laser beam, and an optical apparatus for directing the beam along a beam path. Specifically, the laser beam is generated to establish a predetermined power density over an area “S” at a predetermined point (i.e. focal point) on the beam path. Preferably, this predetermined power density will be in a range between approximately one gigawatt per square meter and about twenty gigawatts per square meter (1-20 GW/m²). With this in mind, the area at the point on the laser beam where this power density is generated will be approximately twenty five square millimeters (S≅25 mm²). Insofar as the solid target itself is concerned, it can either be a pure ceramic material or a compound. Further, the target material is preferably formed as a brick (i.e. block) with a substantially flat surface. More particularly, the target material is preferably manufactured as indicated above and is similar to materials such as a machinable ceramic (Pyrophyllite). As an alternate configuration for the target material, instead of being formed as a brick (block), the target material can be formed as a cylindrical rod.

In the operation of the present invention, the target material is somehow moved relative to the laser beam, or vice versa, with a speed “w”. In either case the purpose is to transition the target material from solid to a vapor. In this transition, the liquid portion (i.e. liquid phase) of the target material in the melt zone is maintained at a substantially constant depth “δ”. Preferably, this depth is on the order of one micron (δ≅1 μm).

In specific cases where the target material is formed as a cylindrical rod, the optical apparatus holds the laser beam stationary while directing the laser beam to the target material. The rod is then advanced along a laser path and through the point on the laser beam where the desired laser power density is being generated. There the target material is vaporized. In the case where the target material is formed as a block having a substantially flat surface, the point on the laser beam where the desired laser power density is being generated is maintained coincident with the surface of the target material. In this latter case, the optical means also moves the point on the laser beam (i.e. melt zone) over the surface of the target material. Preferably, this movement is made along a Lissajous' curve. Further, as disclosure above in the BACKGROUND OF THE INVENTION indicates, Eqn. 5 is controlling.

As intended for the present invention, vaporization of the target material creates a vapor with a throughput in a range between approximately one one-thousandth of a mole per second and one mole per second (0.001-1 mole/sec). Importantly, the power density level of the laser beam, the speed “w” at which the laser beam is moved over the target material, and the path of the laser beam are coordinated to attain a maximum efficiency for the operation of the present invention.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a device in accordance with the present invention, with portions broken away for clarity;

FIG. 2 is a side, elevation view of a rod-like, cylindrical-shaped target material for use with the embodiment shown in FIG. 1;

FIG. 3 is a perspective view of an alternate embodiment of the present invention, shown with an optical steering mechanism, and with portions broken away for clarity; and

FIG. 4 is a cross sectional view of the target material as seen along the line 4-4 in FIG. 3.

### DESCRIPTION OF THE PREFERRED EMBODIMENTS

As a precursor for vaporizing certain solid waste materials (e.g. metal oxides), the present invention envisions these materials will be prepared and presented as targets for laser vaporization, in a ceramic form. To prepare the ceramic, the material that is to be vaporized (e.g. metal oxide) is granulated and mixed with powdered silica (SiO₂). More particularly, the ratio of silica to solid waste material in this mixture is specifically selected so that at temperatures around 2000° C. the thermal expansion of the eventual ceramic will be maintained below the critical strain of the ceramic. As a practical matter, the ratio of metallic oxide waste to silica in the mixture should be approximately 1:1.

Once the mixture has been prepared as disclosed above, it is then sintered to create a ceramic brick (block). Preferably, the resultant ceramic has a thermal expansion coefficient that is below 5×10⁻⁶/° K, and it is formed with a substantially flat, target surface. In particular, as disclosed below in greater detail, a laser beam is directed onto this surface for the specific purpose of vaporizing all, or a substantial amount, of the ceramic brick. Depending on the form of the ceramic target material (i.e. brick or wire), the device for vaporizing the material will have certain characteristics.

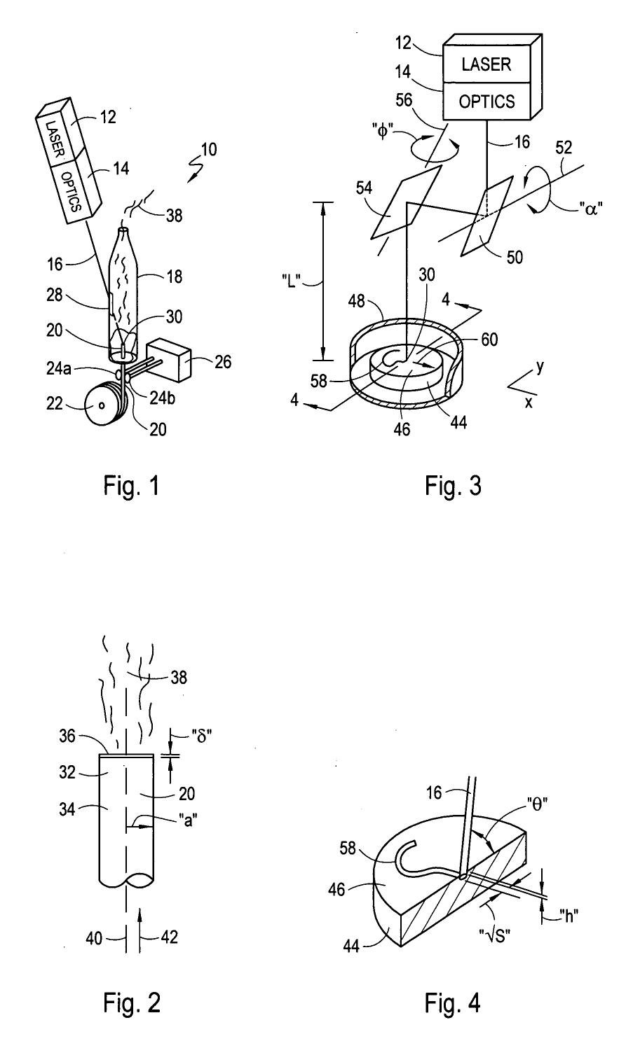

Referring now to FIG. 1, a device for vaporizing a material in accordance with the present invention is shown, and is generally designated 10. As shown, the device 10 includes a laser source 12 which is coupled with appropriate optics 14. Specifically, the laser source 12 can be of any type well known in the pertinent art that is capable of generating a continuous laser beam 16. Further, the optics 14 can be of any type well known in the pertinent art that is capable of focusing the laser beam 16 to a focal spot with a power density that is in a range of about one to about twenty gigawatts per square meter (1-20 GW/m²).

FIG. 1 also shows that the device 10 includes a vessel 18 which receives a target material 20 for vaporization. For the embodiment of the present invention shown in FIG. 1, the target material 20 is substantially cylindrical shaped and has a radius “a” (see FIG. 2). Further, FIG. 1 shows that the target material 20 is supplied from a reel 22, and is advanced into the vessel 18 by counter-rotating feed rollers 24a and 24b. To do this, the feed rollers 24a,b are simultaneously counter-rotated by a drive unit 26. Alternatively, for low ductile materials, such as a cylindrical shaped ceramic target material 20, the target material 20 can be fed directly into the vessel 18.

Still referring to FIG. 1, it is seen that the optics 14 of the device 10 direct the laser beam 16 from the laser source 12, through a window 28 in the vessel 18. Further, the laser beam 16 is focused by the optics 14 to a point 30 inside the vessel 18. Importantly, the laser beam 16 is focused to a focal spot at the point 30 that has an area “S” which is substantially the same as the area of the exposed end 32 (see FIG. 2) of the cylindrical shaped target material 20 (i.e. S=πa²). Recall, the power density over this area will be in an approximate range between one and twenty gigawatts per square meter (1-20 GW/m²).

For purposes of the present invention, it is to be appreciated that the target material 20 will successively progress through three noticeably different phases within the vessel 18. As shown in FIG. 2, these are: a solid phase 34, a liquid phase 36, and a vapor (gas) phase 38. As discussed above, however, it is desirable that little, if any, of the target material 20 be lost during the liquid phase (i.e. liquid throughput is preferably zero: Γ₁=0). Stated differently, it is desirable that the vapor throughput, Γᵥ, be equal to the solid throughput, Γₛ (i.e. Γᵥ=Γₛ). To this end, the target material 20 is fed through the point 30 in vessel 18 (see FIG. 1) along a path 40 in the direction of arrow 42.

FIG. 3 shows an alternate embodiment for the device 10 of the present invention wherein the target material 20 is formed as a brick (block) 44. As shown, the brick 44 is formed with a substantially flat surface 46 and is positioned in a protective receptacle 48 for vaporization. Similar to the embodiment discussed above with reference to FIGS. 1 and 2, for the alternate embodiment, the laser beam 16 is also focused to a focal spot at the point 30. Again, the power density over the area “S” at point 30 will be in an approximate range between one and twenty gigawatts per square meter (1-20 GW/m²). For the alternate embodiment, however, it is necessary that the point 30 of laser beam 16 be somehow moved over the surface 46 to vaporize the target material 20 of brick 44. Alternatively, the point 30 can be held stationary while the brick 44 is moved.

As indicated in FIG. 3, a steering mechanism can be provided for movement of the point 30 of laser beam 16. Specifically, this mechanism may include a mirror 50 that is positioned for rotation around an axis 52 through an angle “α”. The mechanism may also include a mirror 54 that is positioned for rotation around an axis 56 through an angle “φ”. Further, as shown, the mirror 54 is effectively positioned at a distance “L” above the surface 46 of the target material 20 of brick 44. In this combination the axis 52 is oriented perpendicular to the axis 56. Consequently, independent rotations of the mirrors 50 and 54 will respectively result in movements of the point 30 on surface 46 in “x” and “y” directions. For purposes of the present invention, the mirrors 50 and 54 can be of any type well known in the pertinent art, such a galvanometric mirrors.

For the vaporization of target material 20 in brick 44, the point 30 of laser beam 16 is moved over the surface 46 along a curve 58. More specifically, the point 30 is moved along curve 58 with a linear velocity “w” and in a variable direction that, for purposes of disclosure, is indicated by the arrow 60. Preferably, the curve 58 is a Lissajous' curve. Further, it will be appreciated that the result of this movement is a vaporization of target material 20 on the surface 46 that forms a trench having a depth “h” and a width approximated by “√S” (also “2a”) (see FIG. 4). With this in mind, and referring to FIG. 4, various geometrical relationships that are pertinent to the movement of the point 30 can be determined. In general, using approximations, the variables “w”, “L”, “h”, “a”, “θ”, “φ”, and “α” can be used to describe both dimensional and dynamic relationships for the device 10. In this context, it can be dimensionally shown that: tan θ=u/w=h/a. Dynamically, it can be shown that: d(φ;α)/dt=W/L. Using these relationships, it is possible to manipulate the mirrors 50 and 54 to appropriately move the point 30 of laser beam 16 for the selected power density. Importantly, as indicated above, movement of the point 30 (i.e. the melt zone) should be accomplished to satisfy the conditions set forth in Eqn. 5, namely:
u<<w<<[√S/δ]u

While the particular System and Method for Vaporizing a Solid Material as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A method for vaporizing a metallic oxide waste which comprises the steps of:
mixing the metallic oxide waste with silica to prepare a mixture;
sintering the mixture to create a brick of solid material having a target surface; and
focusing a laser beam onto the target surface of the brick to vaporize the metallic oxide waste.

2. A method as recited in claim 1 wherein the solid material has a thermal expansion coefficient below 5×10⁻⁶/° K.

3. A method as recited in claim 1 wherein the ratio of metallic oxide waste to silica in the mixture is selected to maintain thermal expansion of the solid material below the critical strain of the solid material when the solid material is at approximately 2000° C.

4. A method as recited in claim 3 wherein the ratio of metallic oxide waste to silica is approximately 1:1.

5. A method as recited in claim 1 wherein said focusing step includes the steps of:
generating a laser beam having a predetermined power density for creating a melt zone in the solid material, with the melt zone having a depth “δ” where δ=[κ/C]/u, and “κ” is the thermal conductivity of the solid material, “C” is the heat capacity of the solid material, and “u” is the erosion velocity in the melt zone; and
moving the melt zone along a path on the target surface at a velocity “w”, to transition the solid material into a vapor and to create a trench in the target surface having a width “√S” and a depth “h”, wherein h=√Su/w, and “w” satisfies the condition, u<<w<<[√S/δ]u.

6. A method as recited in claim 5 wherein the depth “δ” of the melt zone is less than approximately three hundred microns (δ≦300 μm) and the laser power for generating the predetermined power density is approximately one Kw.

7. A method as recited in claim 5 wherein the vapor is created with a throughput in a range between approximately one one-thousandth of a mole per second and one mole per second (0.001-1 mole/sec), and wherein “w” is maintained above approximately one half meter per second (w≧0.5 m/sec).

8. A method as recited in claim 5 wherein the melt zone is moved along a Lissajous' curve on the target surface of the material and said moving step requires coordinating the movements of a first mirror positioned on the beam path, said first mirror being rotatable about a first axis to move the melt zone in an x-direction on the target surface of the material, and a second mirror positioned on the beam path, said second mirror being rotatable about a second axis to move the melt zone in a y-direction on the target surface of the material.

9. A method as recited in claim 5 wherein the melt zone is moved along a Lissajous' curve on the target surface of the material and said moving step further comprises the steps of:
holding the material in a receptacle; and
moving said receptacle relative to the laser beam.

10. A vaporizing device which comprises:
a solid target material having a substantially flat surface, wherein said solid target material is a ceramic containing silica and a metallic oxide and having a thermal expansion coefficient below 5×10⁻⁶/° K.;
a means for directing a laser beam onto a melt zone at a point on the surface of the target material with a predetermined power density, to transition the target material in the melt zone from a solid to a vapor wherein the melt zone has a depth “δ” where δ=[κ/C]/u, and “κ” is the thermal conductivity of the solid material, “C” is the heat capacity of the solid material, and “u” is the erosion velocity in the melt zone; and
a means for moving the melt zone along a path on the target surface at a velocity “w”, to transition the solid material into a vapor and to create a trench in the target surface having a width “√S” and a depth “h”, wherein h=√Su/w, and “w” satisfies the condition, u<<w<<[√S/δ]u.

11. A device as recited in claim 10 wherein the silica and the metallic oxide are mixed to prepare a mixture, and the mixture is sintered to create a brick of the solid material.

12. A device as recited in claim 10 wherein the ratio of metallic oxide to silica in the mixture is selected to maintain thermal expansion of the solid material below the critical strain of the solid material when the solid material is at approximately 2000° C.

13. A device as recited in claim 10 wherein the ratio of metallic oxide to silica is approximately 1:1.

14. A device as recited in claim 10 wherein the laser power for generating the predetermined power density is approximately one Kw.

15. A device as recited in claim 10 wherein the depth “δ” of the melt zone is less than approximately three hundred microns (δ≦300 μm).

16. A device as recited in claim 10 wherein the vapor is created with a throughput in a range between approximately one one-thousandth of a mole per second and one mole per second (0.001-1 mole/sec).

17. A device as recited in claim 10 wherein “w” is maintained above approximately one half meter per second (w≧0.5 m/sec) and further wherein the material is ceramic.

18. A device as recited in claim 17 wherein said moving means moves the melt zone along a Lissajous' curve on the target surface of the material.

19. A device as recited in claim 17 wherein said moving means comprises:
a receptacle for holding the material; and
a mechanical means for moving said receptacle.

20. A device as recited in claim 17 wherein the laser beam follows a beam path and said moving means comprises:
a first mirror positioned on the beam path, said first mirror being rotatable about a first axis to move the melt zone in an x-direction on the target surface of the material; and
a second mirror positioned on the beam path, said second mirror being rotatable about a second axis to move the melt zone in a y-direction on the target surface of the material.
